(19) United States
(12) Patent Application Publication
(10) Pub. No.: US 2006/0186306 A1
(43) Pub. Date: Aug. 24, 2006

(54) Mounting device with support plate

(76) Inventor: Richard Castle, Olympia, WA (US)

Correspondence Address: David L. Garrison;Suite 3300, 2001 Sixth Avenue, Seattle, WA, 98121-2522, US

(21) Appl. No.: 11/352,068

(22) Filed: Feb. 10, 2006

Related U.S. Application Data
(60) Provisional application No. 60/652,066, filed on Feb. 10, 2005.

(51) Int. Cl. F16M 13/00

(52) U.S. Cl. 248/544; 248/475.1; 248/494; 248/903

(57) ABSTRACT

The present invention describes an improved mounting device or catch intended for mounting mirrors, glass plates or other generally flat objects to walls, doors, cabinets or other similar surfaces. The present invention comprises a plastic shell element, similar in appearance to existing mounting devices, but having a recessed means on its back side to accommodate a support plate. The support plate is a preferably metal, generally J-shaped plate that engages the plastic shell to provide much greater structural integrity to the mounting device. The present invention provides a retainer means by which the support plate is retained by and releasably engages the shell that is easily assembled and allows ease of installation. In addition to strengthening the basic support structure, the metal plate provides a secondary support means that can retain the supported object even in the event of a failure of the plastic shell, potentially preventing the destruction of the supported object. The improved structural features are accomplished while retaining the aesthetic features and resilient support features of prior-art plastic mounting devices.

### CROSS-REFERENCE TO RELATED APPLICATION

This application claims priority to U.S. Provisional Patent Application No. 60/652,066, entitled “MOUNTING DEVICE WITH SUPPORT PLATE,” filed Feb. 10, 2005.

### FIELD OF INVENTION

The present invention relates to a mounting device or catch, and specifically to an easily assembled mounting device with an internal support plate, for mounting objects such as mirrors, unframed pictures covered with a sheet of glass, or other generally flat objects on a flat surface. These devices can be used for mounting such objects, for example, on walls, doors, cabinets or the like, and also on boxes which are provided with hinged lids.

### BACKGROUND OF THE INVENTION

Mirrors and other glass sheets are heavy, hard, and frequently have sharp rectangular edges. There is much prior art regarding devices commonly used for hanging mirrors and other glass sheets to walls, doors, cabinets and other flat surfaces. In this family of devices, hangers are typically made from hard plastics, which are aesthetically pleasing, inexpensive to fabricate and soft and resilient enough to preclude damaging the mirror or glass sheet. For example, U.S. Pat. No. 5,295,651 teaches a plastic mirror mounting clip similar to the present invention, with a slidable mounting configuration. Also, U.S. Pat. No. 4,340,199 teaches a similar hanger having two pieces that are slidably connected.

U.S. Pat. No. 6,244,558 teaches a mounting device for mounting mirrors, glass plates or other generally flat objects to walls, doors, cabinets or other flat surfaces. This mounting device has a plastic shell that is engaged with a support plate to provide greater structural integrity to the mounting device. The shell and support plate are held together as an assembly when a mounting fastener secures the mounting plate between the shell and the mounting surface. While the support plate slidably engages with the plastic shell, no means are provided for retaining the support plate on the plastic shell prior to mounting on a surface. Individual pieces can be difficult to handle during installation, or can be misplaced apart from one another. A need therefor exists for a mounting device with a support plate that can be retained as an assembly before installation, thereby simplifying installation.

In-service failures of these types of mounting devices have been experienced whereby the vertical lip and/or horizontal flanges break, allowing the mirror, glass sheet or other flat object to fall with predictable catastrophic results. This failure mode is a result of the weight of the glass impacting the plastic mounting devices. The local forces on the plastic clips may be further magnified during installation by the speed of the vertical movement when placing the glass sheet on the lower clips, and by the relatively sharp edges of glass sheets, which may concentrate the forces on the clip. A need therefor exists to improve such mounting devices or catches so as to expand their usefulness and make their operation more secure, particularly by addressing the problem of a high in-service failure rate experienced for this type of mounting device.

Mirrors and other glass sheets are virtually ubiquitous in American homes, and the number of in-service mounting devices therefore number in the hundreds of millions. Therefore any reduction in the failure rate for these devices will have a significant aggregate economic impact. For the foregoing reasons, there is a need for an inexpensive mounting clip with improved strength that will support heavy objects such as mirrors and glass plates without breaking.

### OBJECTS OF THE INVENTION

Accordingly, it is an object of the present invention to provide a mounting clip device for mounting mirrors, works of art and other similar objects on a wall or other flat surface that will better withstand the stresses of supporting heavy, hard objects, and will experience fewer in-service failures.

It is another object of the present invention to provide an easily assembled mounting clip having a support plate that is simply, effectively and releasably retained on the clip for holding the clip and support plate together as an assembly prior to installation, thereby providing ease of installation.

It is a further object of the present invention to provide a mounting clip that will provide a secondary support means such that damage to the supported object will be mitigated even in the event of certain modes of failure of the mounting device.

It is a further object of the present invention to provide such mounting clips that retain the aesthetic characteristics of prior mounting devices.

It is a further object of the present invention to provide such mounting clips that are reasonably inexpensive.

It is a further object of the present invention to provide such mounting clips that are not significantly more difficult to install than prior mounting clips.

The present invention is intended to function as the lower, weight-supporting clips, in concert with conventional mounting clips on the upper end of the glass sheet. The present invention achieves its superior structural characteristics by the use of a metal insert designed to fit cooperatively with a plastic shell similar to existing, prior-art mounting devices.

These and such other objects of the invention as will become evident from the disclosure below are met by the invention disclosed herein. In addition to the explicitly claimed apparatus described herein, it is to be understood that all new and useful devices or components described herein are considered to constitute a part of the invention, claimable in their own right, whether such is stated with particularity herein or not.

### SUMMARY OF THE INVENTION

The present invention describes an improved mounting device or catch intended for mounting mirrors, glass plates or other generally flat objects to walls, doors, cabinets or other similar surfaces. The present invention comprises a plastic shell element having a recessed means on its back side to accommodate a support plate. The support plate is a preferably metal, generally J-shaped plate that engages the plastic shell to provide much greater structural integrity to the mounting device. The present invention provides a retainer means by which the support plate is retained by and releasably engages the shell that is easily assembled and allows ease of installation. In addition to strengthening the basic support structure, the metal plate provides a secondary support means that can retain the supported object even in the event of a failure of the plastic shell, potentially preventing the destruction of the supported object. The improved structural features are accomplished while retaining the aesthetic features and resilient support features of prior-art plastic mounting devices.

### BRIEF DESCRIPTION OF THE DRAWINGS

FIG. 1 is a perspective exploded view of a mounting device of the present invention.

FIG. 2 is a rear perspective exploded view of the present invention showing a preferred embodiment for a support plate retainer means.

FIG. 3 is an exploded sectional view of a plastic shell and a metal support plate of the present invention.

FIG. 4 is a fragmentary perspective view of the support plate showing a crimp applied to stabilize the bend in the support plate.

FIG. 5 is a front sectional view of an assembled mounting device of the present invention.

FIG. 6 is a side sectional view of an assembled mounting device of the present invention.

FIG. 7 is an exploded sectional side view of the present invention showing another alternate embodiment for a support plate retainer means.

FIG. 8 is a sectional side view showing an assembled alternate embodiment for a mounting device of the present invention.

FIG. 9 is an exploded sectional side view of the present invention showing another alternate embodiment for a support plate retainer means.

FIG. 10 is a sectional side view showing an assembled alternate embodiment for a mounting device of the present invention.

FIG. 11 is an exploded perspective view of the present invention showing another alternate embodiment for a support plate retainer means.

FIG. 12 is a sectional side view showing an assembled alternate embodiment for a mounting device of the present invention.

### DETAILED DESCRIPTION OF THE INVENTION

Turning now to the drawings, the invention will be described in a preferred embodiment by reference to the numerals of the drawing figures.

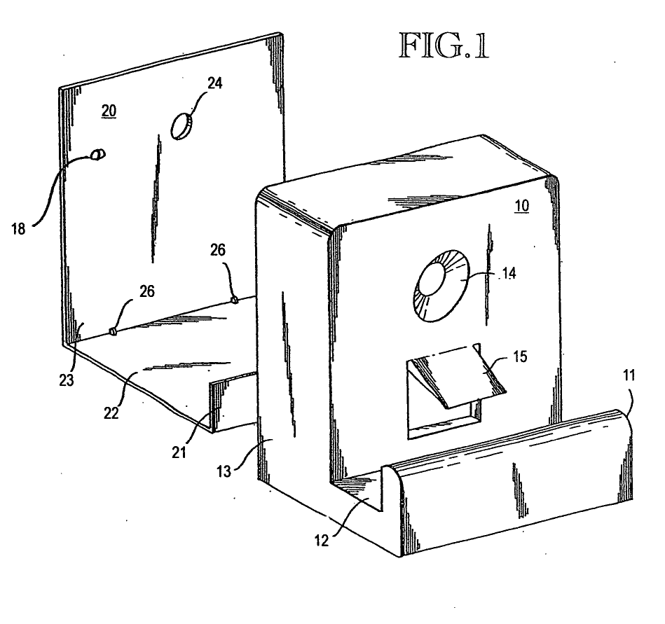

In the preferred embodiment the mounting device provides a structurally improved two-piece supporting clip that is aesthetically very similar to existing mounting devices. The first piece, as shown in FIG. 1, is a plastic shell 10 having external support-side contours that are similar to prior-art mounting devices. The plastic shell 10 has a base portion 13 having a recessed hole 14 along its centerline to accommodate an attachment means such as a screw for attaching the device to a wall, door or other surface. A hook portion 12 depends vertically from the lower edge of the base portion 13, providing a generally horizontal surface for supporting a mirror, glass plate or other similar object. An integral lip 11 depends vertically from the end of the hook portion 12 farthest from the base portion 13. The base portion 13 and hook portion 12 with integral lip 11 provide a generally J-shaped hook for supporting and retaining any flat object. The base portion includes a resilient tongue 15, preferably formed as an integral part of the shell 10 and depending at an angle from approximately the center of the shell 10 towards the lip 11, to provide a spring-like means for holding the flat object against the lip thereby preventing any rattling or undesirable lateral movement of the flat object.

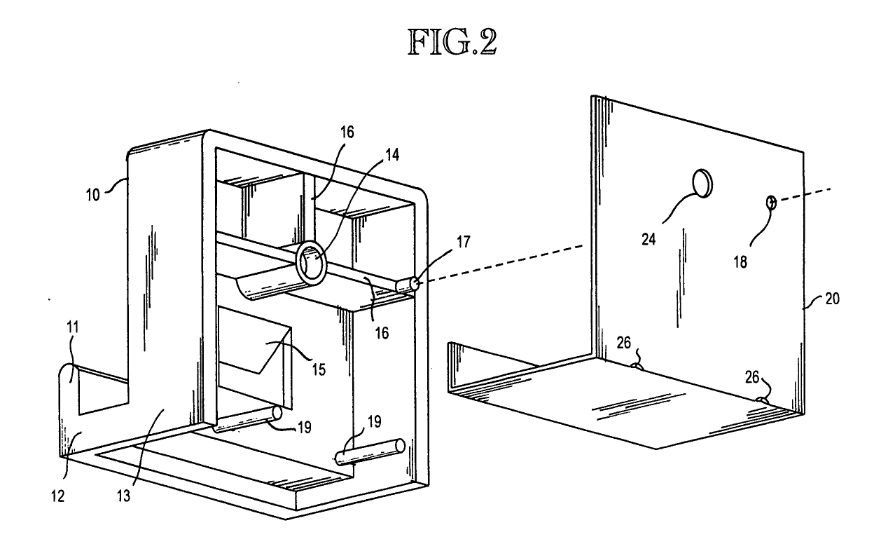

As shown in FIG. 2, the back side of the shell 10 is fabricated to have a recessed area generally along the entire back side of the shell 10. In the preferred embodiment, the recessed area has integral support members 16 bridging the inner sides of the shell and forming a support for the recessed hole 14. More or fewer support members may be provided in alternate embodiments. A solid piece of plastic may be used in yet another embodiment to provide the necessary integral support. A pair of retainer tabs 17 extend rearwardly into the recess providing a retainer means for the shell. In the preferred embodiment, two additional spacer tabs 19 are molded into the plastic shell and extend rearwardly into the recess. The recessed portion preferably culminates on the lip-end with a rectangular channel protruding into the lip 11 portion of the shell, generally along the center-plane of the lip 11 portion.

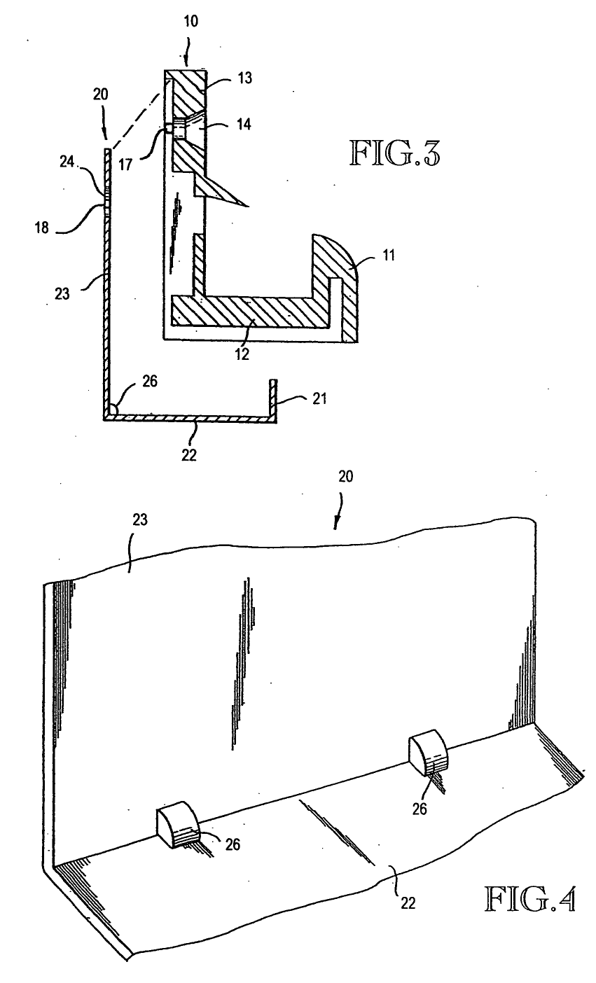

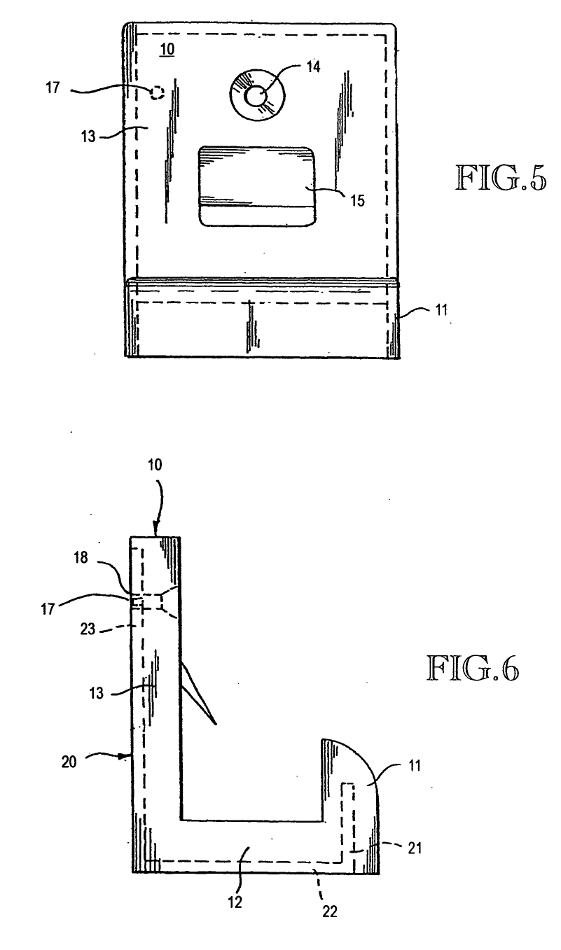

FIGS. 1 and 2 show a second piece of the mounting device is a metal support plate 20 preferably stainless steel formed from a single generally rectangular piece of metal. In the preferred embodiment the support plate 20 is made from quarter-hardened stainless steel. The support plate 20 has a back portion 23 sized to fit into the recess on the back portion 13 of the shell 10, and has a hole 24 located along its centerline and positioned such that when the support plate back portion 23 is inserted into the back portion 13 of the shell 10 the hole 24 is aligned with the recessed hole 14 in the shell 10. The support plate has two additional apertures 18 aligned to engage with the retainer tabs 17 of the shell 10. A hook portion 22 depends perpendicularly from the lower end of the back portion 23 of the support plate 20, and is sized to fit into the recess on the bottom of the hook portion 12 of the shell 10 as shown in FIG. 3. In the preferred embodiment the hook portion 22 is formed by bending the stainless steel plate approximately ninety degrees and applying a crimp 26 to the metal in at least one location along the bend as shown in FIG. 4. The crimp or crimps 26 significantly increase the strength and stability of the support plate 20. An integral lip 21 depends vertically from the end of the hook portion 22 of the back plate 20, and is sized to slidably fit into the rectangular channel protruding into the lip 11 of the shell 10. The lip 21 is preferably formed by bending the hook portion 22.

As can best be seen in FIG. 3, in this embodiment the support plate 20 may be slidably inserted into the plastic shell 10 by positioning the support plate 20 below the shell 10 with the lip 21 portion of the support plate 20 aligned with the rectangular channel in the lip 11 portion of the shell and sliding the support plate 20 vertically into the shell 10. With the lip portion of the support plate 20 held within the rectangular channel in the lip 11, the support plate 20 is then positioned upward such that the retainer tabs 17 of the shell 10 engage the apertures 18 of the support plate 20. Spring tension provided by the support plate 20 enables slight bending of the support plate so that the retainer tabs 17 and apertures 18 will engage, and also enables the support plate 20 to grab onto the retainer tabs 17 to hold the shell 10 and support plate 20 together as an assembly. A simple action of bending the support plate 20 back slightly from the retainer tabs 17 will enable the support plate 20 to be released from the shell 10. A complete assembly of the plastic shell 10 and metal support plate 20 is shown in FIGS. 3 and 4. Within the recess of the shell 10, the support plate 20 engages a surface on the back side of the shell formed by the integral support members 16 and the two spacer tabs 19.

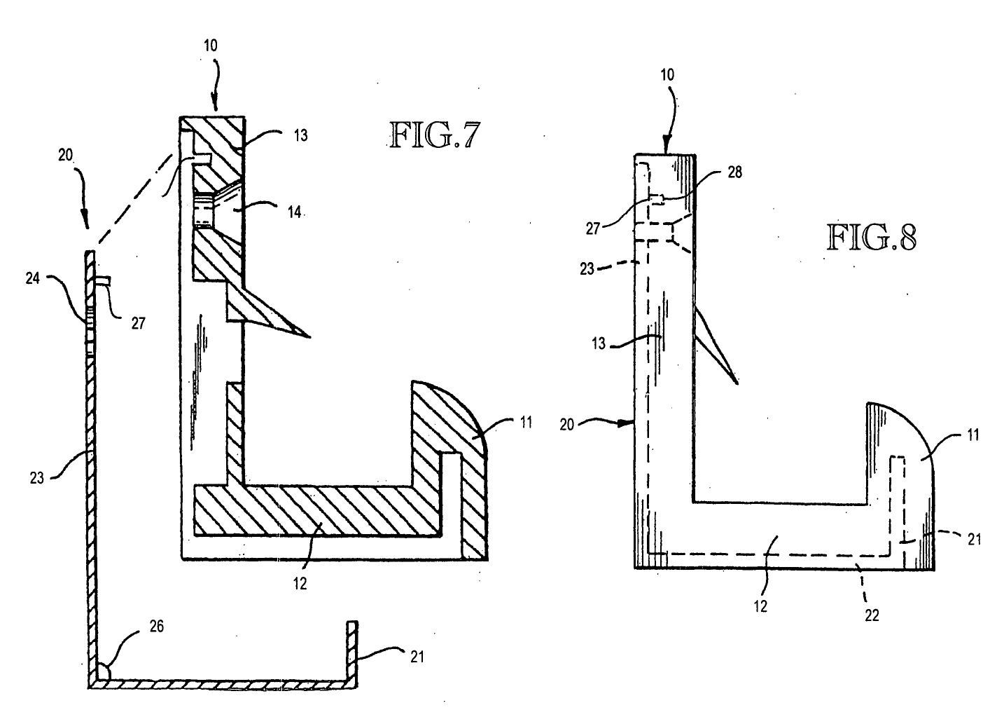

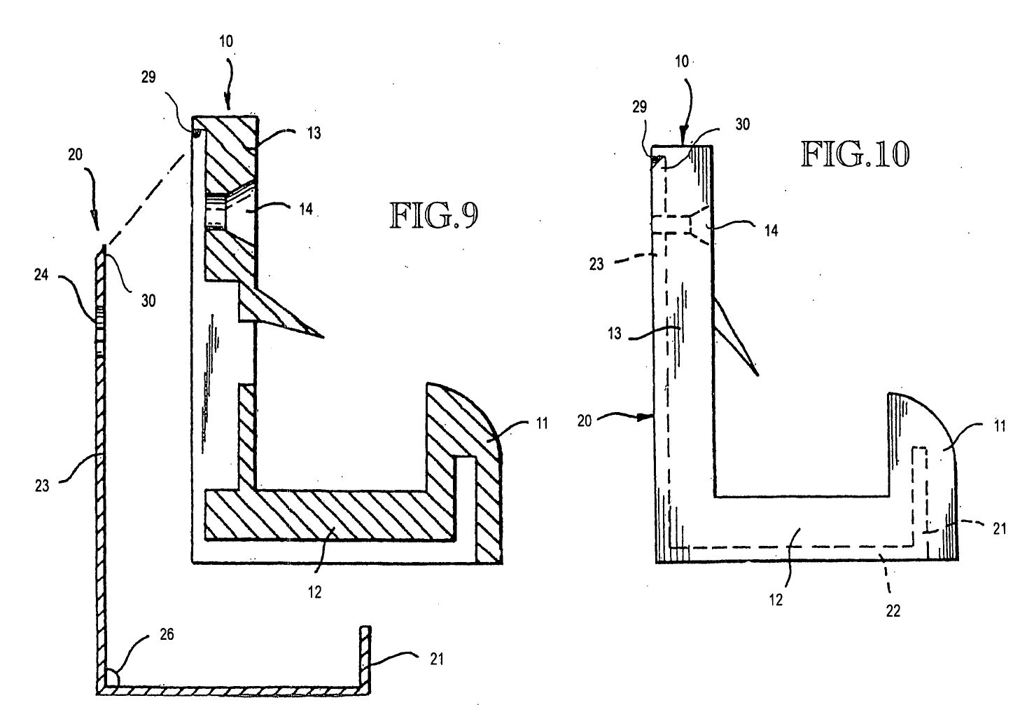

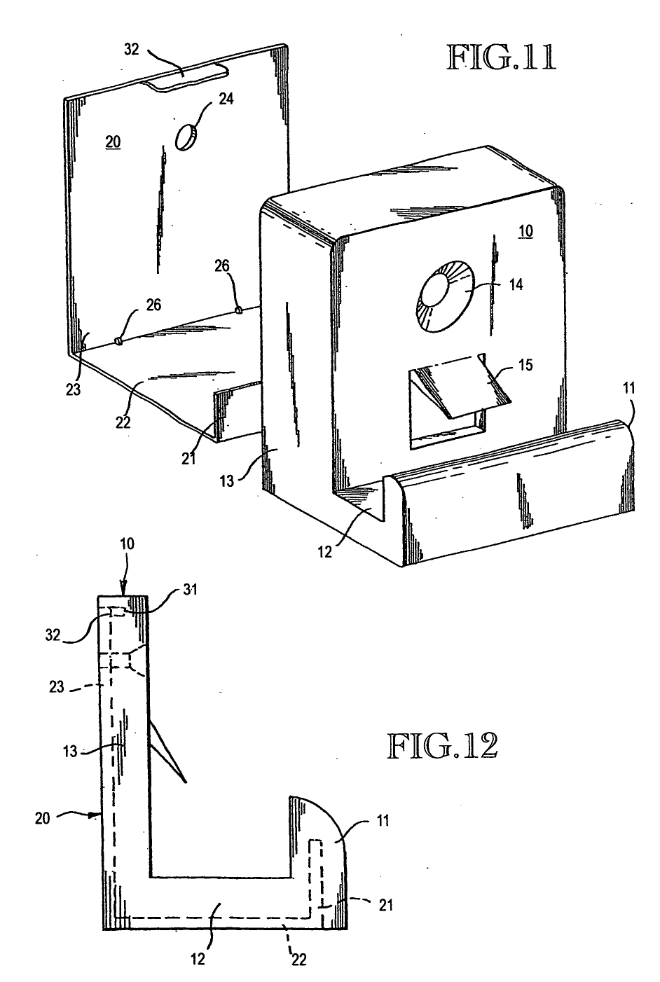

It will be obvious to one skilled in the art to provide any of several alternate embodiments for a retainer means by which the support plate 20 is retained by and releasably engages the shell 10. An alternate embodiment as shown in FIGS. 7 and 8 is a mounting device of the present invention having an embossed retainer tab 27 integral with the support plate 20 and located along an outer edge of the support plate 20, aligned to engage an aperture 28 in the recess of the shell. Another alternate embodiment as shown in FIGS. 9 and 10 is a mounting device of the present invention having a raised ridge 29 along an inner edge within the recess of the shell 10 that is aligned with an upper edge 30 of the support plate 20, whereby the top edge of the support plate 20 is retained by an interference fit within the top of the plastic shell 10. Yet another embodiment as shown in FIGS. 11 and 12 is a mounting device of the present invention having channel 31 within an outer edge of the recess of the shell 10 aligned with a raised forward-facing tab 32 integral with the support plate 20, whereby the top of the support plate 20 engages the channel thus retaining the support plate 20 against the shell 10.

The support plate 20 strengthens the hook portion 12 and integral lip 11 of the shell 10, which is a common point of failure for prior art mounting devices. In addition, the back portion 23 of the support plate 20 reinforces the mounting device at the location of attachment to the wall, door or other surface.

The intended application of the present invention is as follows: In the manufacturing process, the plastic shell with associated features described herein above is molded as with a vacuum molding process for plastic that is common in the prior art. The support plate is stamped or cut from sheet metal, the above-described apertures being drilled, stamped or cut, and then bent to form the required angle features. The shell and support plate may simply assembled together by hand or automated means and packaged as an assembled mounting device, or the shell and support plate may be packaged separately for later assembly by a consumer. Whether assembled during manufacturing or after sale to a consumer, the support plate is slidably inserted into the plastic shell by positioning the support plate below the shell with the lip portion of the support plate aligned with the rectangular channel in the lip portion of the shell and sliding the support plate vertically into the shell, bending the support plate outward slightly to positioning, align and engage the retainer means between the shell and the support plate. The spring tension of the support plate will ensure engagement of the retainer means following assembly. Disassembly is achieved by simply reversing the assembly process starting with a slight bending of the support plate as by inserting and pulling with a finger nail. The assembled mounting device is secured to a wall or other suitable flat surface by a common fastener such as a wood screw, a machine screw, or screw-type wall anchor. Mounting devices of the present invention will be ideally used in multiples to balance the load of an item to be supported, and to secure it, at minimum, at locations along top and bottom edges of the item.

It is particularly beneficial that the metal support plate 20 provides a secondary means of retaining the supported mirror, glass plate or other object even if the shell 10 experiences a failure. In prior art mounting devices a failure of the device will inevitably result in the supported object falling from its mounting position, with generally predictable catastrophic results to the supported object. In the present invention, if the shell 10 cracks or breaks into multiple pieces, the metal support plate 20 will continue to support the object with no damage, or minimal damage, until the supporting device can be repaired or replaced.

It is also noted that the aesthetic and resilient support features of prior-art plastic mounting devices are retained in the present invention. As can best be seen in FIGS. 2 and 3, the metal support plate 20 is not directly visible from the front or side view of the mounting device. Moreover, the plastic shell 10 is the only part of the present mounting device that contacts the supported object. Therefore the present invention retains the feature of prior-art devices, resisting scratching or other damage to the supported devices.

It will be obvious to one of ordinary skill in the art that a wide range of alternative embodiments may be produced having many of the advantages of the preferred embodiment described above.

### INDUSTRIAL APPLICABILITY

The present invention has applicability to the field of a mounting device or catch, and specifically to a mounting device with an internal support plate for objects such as mirrors, unframed pictures covered with a sheet of glass, or other generally flat objects.

In compliance with the statute, the invention has been described in language more or less specific as to mounting devices or catches. It is to be understood, however, that the invention is not limited to the specific means or features shown or described, since the means and features shown or described comprise preferred ways of putting the invention into effect.

Additionally, while this invention is described in terms of being used for a mounting device or catch, it will be readily apparent to those skilled in the art that the invention can be adapted to other uses in industry and for other forms of device assembly, and therefore the invention should not be construed as being limited to mounting devices. The invention is, therefore, claimed in any of its forms or modifications within the legitimate and valid scope of the appended claims, appropriately interpreted in accordance with the doctrine of equivalents.

What is claimed is:

1. A mounting device for mounting mirrors, works of art or other objects on an essentially flat surface, the mounting device comprising:
i. a shell having a front side and a back side, said shell having a recess on said back side, and said shell comprising a base plate having at least one retainer means extending rearwardly into the recess, and having a hook portion extending forwardly from said front side from one edge of said back plate, said hook portion having an integral lip portion extending from said hook portion approximately parallel to said base plate such that said shell is generally J-shaped, and said lip portion having a rectangular channel extending partially therethrough; and
ii. a support plate having a generally J-shape and sized to slidably fit into said recess on the back side of said shell and into said rectangular channel in the lip portion of said shell, the support plate having at least one retainer receiving means in a forward facing surface aligned with the at least one rearwardly extending retainer means of the base plate, whereby the support plate is retained by and releasably engages the shell with the retainer means extending into the retainer receiving means of the support plate.

2. The mounting device of claim 1 wherein said back plate of said shell further comprises a resilient tongue protruding forwardly from said base plate.

3. The mounting device of claim 1 wherein said back plate further comprises a recessed hole therethrough to accommodate a fastening means for attachment to an external surface, and wherein said support plate further comprises a hole therethrough located such that said hole is aligned with said recessed hole when said support plate is slidably inserted into said shell.

4. The mounting device of claim 1 wherein said back plate further comprises at least one integral reinforcement member within said recess, whereby the plastic shell is reinforced to reduce structural failure of the mounting device.

5. The mounting device of claim 4, whereby the integral reinforcement member is a molded bridge connecting two or more surfaces within the recess.

6. The mounting device of claim 1 wherein said retainer means comprises an embossed tab integral with the shell, and the retainer receiving means comprises an aperture aligned with the embossed tab.

7. The mounting device of claim 1 wherein said retainer means comprises an aperture in the shell, and the retainer receiving means comprises an embossed tab integral with the support plate, whereby the embossed tab is aligned with the aperture in the shell.

8. The mounting device of claim 1 wherein said retainer means comprises a raised ridge within an outer edge of the recess of the shell, and the retainer receiving means comprises an outer edge of the support plate aligned with the raised ridge, whereby the raised ridge retains the outer edge of the support plate.

9. The mounting device of claim 1 wherein said retainer means comprises a channel within an outer edge of the recess of the shell, and the retainer receiving means comprises a forward-facing raised tab on an outer edge of the support plate aligned with the channel.

10. The mounting device of claim 1 wherein said support plate is made from a single piece of quarter-hardened stainless steel.

11. The mounting device of claim 1 wherein said support plate comprises of a single piece of quarter-hardened stainless steel having two approximately ninety degree bends therein to form said J-shape and wherein at least one of said ninety degree bends has at least one crimp therein.

12. A mounting device for mounting mirrors, works of art or other objects on an essentially flat surface, the mounting device comprising:
i. a metal support plate comprising a first vertical portion, at least one aperture extending through the vertical portion, a horizontal portion and a second vertical portion, said vertical and horizontal portion forming a generally J-shape;
ii. a shell encasing said metal support plate, said shell comprising a vertical base plate covering said first vertical portion of said metal support plate, at least one retention tab extending outwardly from the base plate and aligned with the at least one aperture in the vertical portion for retention by and releasable engagement with the metal support plate by the plastic shell, and an integral hook portion extending horizontally therefrom, covering said horizontal portion and said second vertical portion of said metal support plate.

13. The mounting device of claim 12 wherein said base plate further comprises a recessed hole therethrough to accommodate a fastening means for attachment to an external surface, and wherein said support plate further comprises a hole therethrough located such that said hole is aligned with said recessed hole when said support plate is slidably inserted into said shell.

14. The mounting device of claim 12 wherein said back plate further comprises at least one integral reinforcement member within said recess, whereby the plastic shell is reinforced to reduce structural failure of the mounting device.
